(19) United States
(12) Patent Application Publication
(10) Pub. No.: US 2007/0012730 A1
(43) Pub. Date: Jan. 18, 2007

(54) Methods and apparatus for dispensing particulates

(75) Inventor: John Pailthorp, Alpharetta, GA (US)

Correspondence Address: JOHN S. BEULICK;C/O ARMSTRONG TEASDALE, LLP, ONE METROPOLITAN SQUARE, SUITE 2600, ST LOUIS, MO, 63102-2740, US

(73) Assignee: United Industries Corporation

(21) Appl. No.: 11/487,100

(22) Filed: Jul. 12, 2006

Related U.S. Application Data
(60) Provisional application No. 60/698,705, filed on Jul. 13, 2005.

(51) Int. Cl. B67D 3/00

(52) U.S. Cl. 222/478

(57) ABSTRACT

An apparatus facilitates dispensing a particulate. The apparatus includes a hollow container, a shaker cap, a third opening, a control mechanism, and a rotating member. The hollow container includes a body extending from a top end to a bottom end. The body includes a storage portion and a dispensing portion in flow communication with the storage portion. The body top end includes a first opening. The shaker cap is removably coupled to the container top end to selectively control access to the first opening. The shaker cap includes a lid and at least one second opening. The third opening is defined within a side wall of the dispensing portion. The control mechanism is coupled in flow communication with the third opening for selectively opening and closing said third opening. A rotating member is positioned within the dispensing portion for selectively dispensing particulate through the dispensing portion third opening.

### CROSS REFERENCE

This application claims the benefit of U.S. provisional patent application 60/698,705 filed Jul. 13, 2005 all of which is incorporated by reference in its entirety.

### BACKGROUND OF THE INVENTION

This invention relates generally to dispensing particulates and, more particularly to methods and apparatus for dispensing particulates.

A variety of particulate dispensing devices or spreaders are well known in the industry. At least some of such spreaders include an open-ended hopper that is coupled between a pair of wheels used to propel the hopper. The hopper slopes downward towards a broadcast or discharge port in the bottom of the spreader. However, such spreaders are limited to only dispensing particulates through the broadcast port because of the open-ended hopper. To facilitate preventing foreign objects from inadvertently entering such hoppers, at least some of such hoppers include a solid screw top or a hinged lid that is secured to a top edge of the hopper.

Other known spreaders are hand-held spreaders that include a hopper that feeds a rotating impeller assembly through a slotted opening that is coupled to an actuating assembly. However, within such spreaders, the actuating assembly limits the user to only using the spreader to discharge the product contained therein through broadcast dispensing, increases manufacturing cost, and may increase the likelihood of potential malfunctions.

To overcome these and other problems related to use of known spreaders, the present invention provides methods and apparatus for dispensing particulate from a single container that enables particulate to be dispensed through a shaker top and/or through a broadcast dispenser. In addition, the present invention provides a single container that is optionally reusable. The above advantages and novel features, as well as other features and advantages, of the present invention will become apparent from the description provided in the present Specification and from the accompanying drawings.

### BRIEF DESCRIPTION OF THE INVENTION

In one aspect, an apparatus for dispensing a particulate is provided. The apparatus includes a hollow container, a shaker cap, a plurality of openings, a control mechanism, and a rotating member. The hollow container includes a body extending from a top end to a bottom end. The body includes a storage portion and a dispensing portion in flow communication with the storage portion. The body top end includes a first opening. The shaker cap is removably coupled to the container top end to selectively control access to the first opening. The shaker cap includes a lid and at least one second opening. A third opening is defined within a side wall of the dispensing portion. The control mechanism is coupled in flow communication with the third opening for selectively opening and closing the third opening. A rotating member is positioned within the dispensing portion for selectively dispensing particulate through the dispensing portion third opening.

In another aspect, a particulate dispenser is provided. The dispenser includes a hollow container, a shaker cap, a plurality of openings, a control mechanism, and a dispensing handle. The hollow container includes a body extending from a top end to a bottom end. The body includes a storage portion and a dispensing portion in flow communication with the storage portion. The shaker cap is removably coupled to the container top end to selectively control access to a first opening defined in the top end. The cap includes at least one second opening. A third opening is integrally formed within a side wall of the dispensing portion. The control mechanism is coupled in communication with the dispensing portion third opening for controlling particulate flow from the storage portion to the dispensing portion. The dispensing handle includes a collapsible arm. The handle is operable to selectively discharge particulate from the dispensing portion.

In a further aspect, a method for dispensing particulate from a container having a body extending from a top end to a bottom end is provided. The method comprises inserting a particulate to be dispensed from the container into a storage portion of the container body through a first opening formed in the top end of the container, and coupling a lid to the container to facilitate preventing particulate from inadvertently exiting the container through the first opening. The method also includes selectively dispensing particulate from the container through at least one of a second opening formed in the lid and a third opening formed in a dispensing portion of the container, wherein the dispensing portion of the container is positioned in flow communication with the storage portion of the container.

### BRIEF DESCRIPTION OF THE DRAWINGS

FIG. 1 illustrates a rear perspective view of an exemplary dispensing container;

FIG. 2 illustrates a side view of the dispensing container illustrated in FIG. 1;

FIG. 3 illustrates a rear view of the dispensing container illustrated in FIG. 1; and

FIG. 4 illustrates a front view of the dispensing container illustrated in FIG. 1.

### DETAILED DESCRIPTION OF THE INVENTION

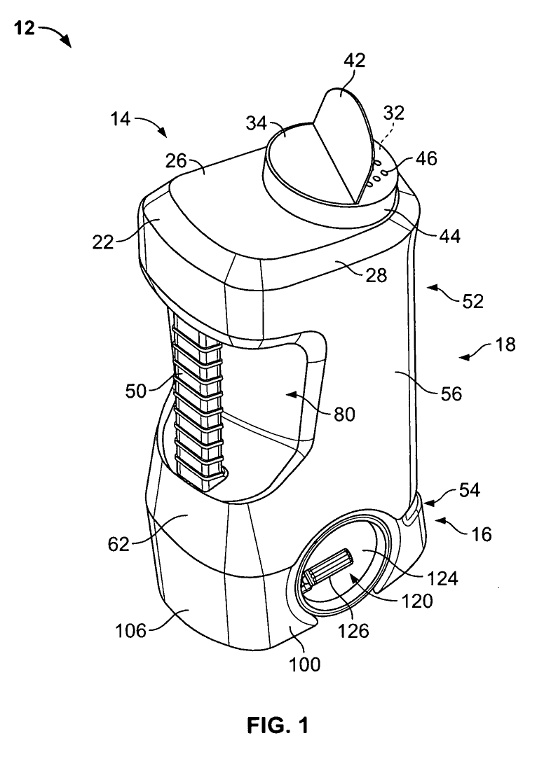

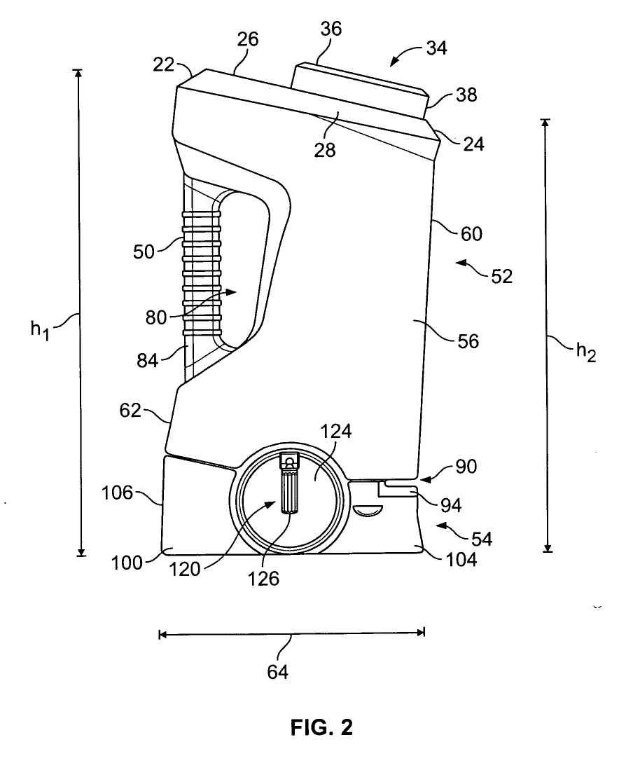

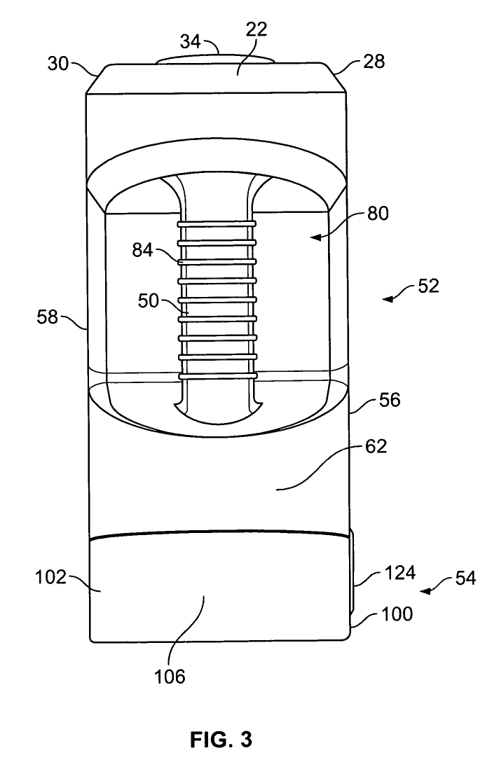

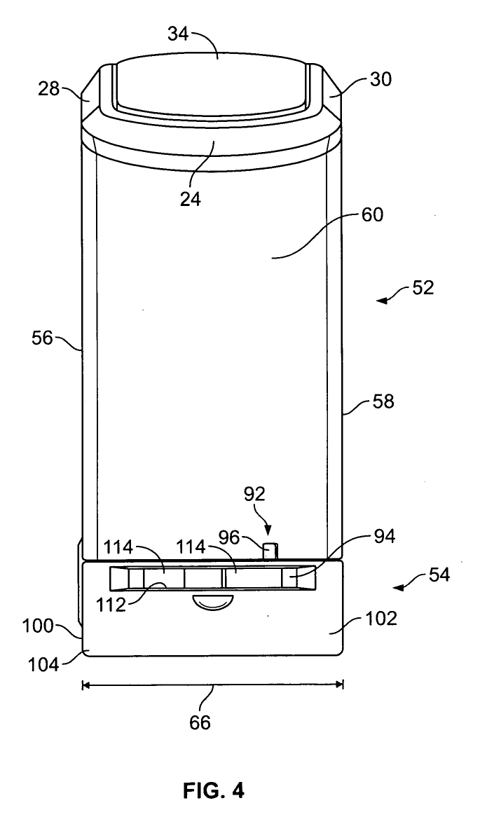

FIG. 1 illustrates a rear perspective view of an exemplary dispensing container 12 that may be used to dispense any particulate, such as, but not limited to, seed, fertilizer, sand, dirt, pebbles, rocks, dust, and/or other particulate matter. FIG. 2 illustrates a side view of container 12, and FIG. 3 illustrates a rear view of container 12. FIG. 4 illustrates a front view of container 12. In the exemplary embodiment, container 12 has a substantially elliptical cross-sectional shape. In other embodiments, container 12 may be formed with any other cross-sectional shape, whether, varied or substantially constant, such as, but not limited to, a square cross-sectional shape, a rectangular cross-sectional shape, and/or any non-elliptical cross-sectional shape that enables container 12 to function as described herein.

Container 12 includes a hollow body 18 that extends from a top end 14 to a bottom end 16 of container 12. In some embodiments, only portions of body 18 are hollow. Top end 14 extends from a rear side or end wall 22 of container 12 to a front side or front end wall 24. A top surface 26 extends between container rear and front sides 22 and 24, respectively, and is bounded by a pair of opposing side walls 28 and 30 that extend between front and rear end walls 22 and 24, respectively. In the exemplary embodiment, top end 14 is sloped, with respect to bottom end 16, from rear side 22 towards front end 24, such that rear side 22 has a height h₁, measured from bottom end 16 to top end 14, which is taller than a corresponding height h₂ of front end 24. In the exemplary embodiment, an opening 32 is defined in top surface 26 adjacent to front side 24. In the exemplary embodiment, top surface 26 has a substantially elliptical cross-sectional shape and opening 32 is substantially circular. In other embodiments, opening 32 may be formed with any other shape, such as, but not limited to, a square shape, a rectangular shape, and/or any non-circular cross-sectional shape.

In the exemplary embodiment, opening 32 is defined by a lip (not shown) that extends substantially perpendicularly outward from top surface 26. In some embodiments, the lip is threaded and is configured to removably couple with a shaker cap 34 via a threaded connection. In some embodiments, the lip is configured to removably couple to cap 34 via a mechanical connection, such as, but not limited to, a snap-fit connection or a quick-disconnect type connection in which the cap 34 is removable from the lip after being only partially-rotated relative to the lip. In the exemplary embodiment, cap 34 has a top surface 36 and an outer sidewall 38 that extends substantially perpendicularly from cap top surface 36. In the exemplary embodiment, cap sidewall 38 includes a radially outer surface 44 and an opposite radially inner surface (not shown) that enables cap 34 to be removably coupled to container 12 such that particulate contained within container body 18 is substantially sealed from the outside environment.

In the exemplary embodiment, cap top surface 36 includes a lid 42 that is coupled via a hinge to container 12 and is selectively positionable to seal/expose a plurality of shaker openings 46. In the exemplary embodiment, cap 34 is substantially circular. In other embodiments, cap 34 may be formed with other shapes, such as, but not limited to, a square shape, a rectangular shape, and/or any non-circular cross-sectional shape that enables cap 34 to function as described herein. Cap 34 enables particulate to enter container body 18 and based on a position of lid 42, also enables selective discharge of particulates from container body 18. Lid 42 facilitates preventing the inadvertent discharge of particulate from container 12 during transit and during dispensing operations. Shaker openings 46 facilitate controlled dispensing or patch dispensing of particulate from container 12.

In the exemplary embodiment, body 18 includes a handle 50, a storage portion 52, and a dispensing portion 54 that are each formed integrally within body 18. Body 18 includes a pair of opposed side walls 56 and 58 that extend between front and rear walls 60 and 62, respectively. In the exemplary embodiment, side walls 56 and 58 are substantially parallel, and front and rear walls 60 and 62 are substantially parallel to each other, and as such, are substantially perpendicular to side walls 56 and 58. Side walls 56 and 58 each have a first width 64, and front and rear walls 60 and 62 each have a second width 66. In the exemplary embodiment, width 64 is different than width 66. Alternatively, widths 64 and 66 may be selected to be any length. In one embodiment, first width 64 is approximately 7.90 inches and second width 66 is approximately 5.20 inches. In alternative embodiments, first width 64 and second width 66 may be any length that enables container 12 to function as described herein.

In the exemplary embodiment, handle 50 is formed adjacent a recess or handle cavity 80 defined by sidewall 62. More specifically, in the exemplary embodiment, handle 50 is positioned within the footprint circumference of top surface 26, as defined by walls 22, 24, 26, and 28. In the exemplary embodiment, handle 50 is hollow and has a substantially rectangular cross-sectional shape. In alternative embodiments, handle 50 may be formed with any other shape, such as, but not limited to, a square shape and/or any non-rectangular cross-sectional shape. Handle cavity 80 is defined between body 18 and handle 50 to enable a user to easily grasp handle 50 with a plurality of fingers. In the exemplary embodiment, handle 50 is ergonomically designed and includes a plurality of ridges or grips 84 that provide a surface that facilitates more easily grasping handle 50, while preventing container slippage during dispensing operations.

In the exemplary embodiment, storage portion 52 is defined within, and is formed integrally with, body 18. Storage portion 52 extends between top end 14 and dispensing portion 54 such that at least a portion of storage portion 52 is in flow communication with handle 50 and dispensing portion 54. In the exemplary embodiment, storage portion 52 has substantially elliptically cross-sectional shape. In alternative embodiments, storage portion 52 may be formed with any other cross-sectional shape, such as, but not limited to, a square shape, a rectangular shape, and/or any non-circular cross-sectional shape. In one embodiment, storage portion 52 is sized to receive between approximately 2.5 pounds and approximately 3.0 pounds of particulate. In other embodiments, the volume of storage portion 52 may be larger or smaller that the above indicated volume, depending upon the particular application. Storage portion 52 enables particulate to be stored prior to, and during, dispensing operations.

In the exemplary embodiment, dispensing portion 54 extends between storage portion 52 and bottom end 16, and includes a broadcast opening 90, a valve 92, and a rotating member 94. In the exemplary embodiment, dispensing portion 54 has a substantially elliptical cross-sectional shape. In other embodiments, dispensing portion 54 may be formed with any other cross-sectional shape, such as, but not limited to, a square shape, a rectangular shape, and/or any non-circular cross-sectional shape.

In the exemplary embodiment, dispensing portion 54 includes a pair of opposing side walls 100 and 102 that extend between front and rear walls 104 and 106, respectively. Alternatively, dispensing portion 54 may be formed with any shape, any number of side walls, and/or a continuous sidewall. In the exemplary embodiment, side walls 100 and 102 are substantially parallel to each other, and front and rear walls 104 and 106 are substantially parallel to each other. Moreover, in the exemplary embodiment, side walls 100 and 102 each have the same width 64 as body side walls 56 and 58, and front and rear walls 104 and 106 have the same width 66 as front and rear walls 60 and 62. In the exemplary embodiment, dispensing portion 54 and storage portion 52 are formed integrally together. In alternative embodiments, dispensing portion 54 and/or storage portion 52 are formed as multi-piece assemblies that are coupled together via a plurality of fasteners.

In the exemplary embodiment, broadcast opening 90 is formed integrally within front wall 104 of dispensing portion 54. More specifically, in the exemplary embodiment, opening 90 extends substantially horizontally through at least a portion of front wall 104 to enable particulate contained in storage portion 52 to be selectively discharged outwardly, and generally forward of, container 12. Opening 90, in the exemplary embodiment, also extends at least partially through side walls 100 and 102 such that particulate is dispensed outwardly from container front side 24. Broadcast opening 90 may have any shape that facilitates broadcasting particulate in any desired pattern(s).

In the exemplary embodiment, a control valve 92 is positioned within dispensing portion 54 and is operatively coupled in flow communication with broadcast opening 90 to selectively open and close broadcast opening 90. In the exemplary embodiment, valve 92 includes an actuator 96 that extends generally radially outward from opening 90 to enable a user to selectively open and close opening 90. In some embodiments, valve 92 is manually positionable via selective movement of arm 96. In other embodiments, valve 92 is positionable using an actuating assembly, such as, but not limited to a trigger mechanism.

In the exemplary embodiment, a rotating member 94 is rotatably coupled within body dispensing portion 54 adjacent broadcast opening 90 to enable particulate to be dispensed through opening 90. In the exemplary embodiment, rotating member 94 includes at least one gear and a substantially planar base 112 that includes a plurality of dispensing portions 114 extending substantially perpendicularly therefrom. In the exemplary embodiment, rotating member 94 is positioned entirely within side walls 100 and 102 and front wall 104. In other embodiments, a portion of rotating member 94 extends through opening 90. In each embodiment, rotating member 94 is positioned to facilitate discharging the particulate forward from container 12.

In the exemplary embodiment, a dispensing handle 120 is coupled to rotating member 94 to control rotation of member 94. In the exemplary embodiment, dispensing handle 120 is coupled to a gear 122 that is mechanically coupled to rotating member 94 for rotation therewith. In other embodiments, handle 120 is coupled directly to member 94 for rotation therewith, or is coupled to a plurality of gears mechanically coupled to rotating member 94. In the exemplary embodiment, when in a stored position, handle 120 is substantially flush with dispensing portion side wall 100. In another embodiment, dispensing handle 120 is stored within a recess defined within dispensing portion 54. Handle 120 includes a substantially circular body 124 and an arm 126 that is movable between a stored position and an in-use position in which arm 126 extends substantially perpendicular outward from body 124 to enable body 124, and rotating member 94 to be rotated.

In operation, cap 34 is temporarily removed and particulate is stored within storage portion 52 until full. Cap 34 is re-secured to container 12 and the user has the option of lifting cap lid 42 and shaking a limited amount of particulate over a small surface area from an inverted container 12, or closing cap 34 opening valve 92, and dispensing particulate through opening 90 using rotating member 94 and handle 120. For example, when valve 92 is open, particulate can fall into or is gravity-fed into rotating member 94, wherein rotating handle 120 enables the particulate to be broadcast over a large surface area.

The above-described container for dispensing a particulate is convenient to use and reliable. The container includes two openings for dispensing particulates such that the container facilitates providing the user with the choice of broadcast distribution or controlled patchwork distribution. The container also includes a cap for the first opening and a valve for the second opening such that the container facilitates sealing the particulate inside from exposure to outside atmospheric conditions.

The present invention has been described in connection with specific examples and combinations of materials and structures. However, it should understood that they are intended as exemplary, rather than in any way limiting the scope of the invention. The container described herein may be utilized independently and separately with other components other than those described herein. Moreover, the container can also be used to dispense materials other than particulates.

While the invention has been described in terms of various specific embodiments, those skilled in the art will recognize that the invention can be practiced with modification within the spirit and scope of the claims.

What is claimed is:

1. An apparatus for dispensing a particulate, said apparatus comprising:
a hollow container comprising a body extending from a top end to a bottom end, said body comprising a storage portion and a dispensing portion in flow communication with said storage portion, said body top end comprising a first opening;
a shaker cap removably coupled to said container top end to selectively control access to said first opening, said shaker cap comprising a lid and at least one second opening;
a third opening defined within a side wall of said dispensing portion;
a control mechanism coupled in flow communication with said third opening for selectively opening and closing said third opening; and
a rotating member positioned within said dispensing portion for selectively dispensing particulate through said dispensing portion third opening.

2. Apparatus in accordance with claim 1 wherein said rotating member comprises at least one rotatable gear and a planar base coupled to said at least one gear, said planar base comprising a plurality of dispensing portions extending perpendicularly therefrom.

3. Apparatus in accordance with claim 1 further comprising a dispensing handle coupled to said rotating member to control movement of said rotating member; for rotation therewith, said dispensing handle comprising a circular body and a collapsible arm extending from said circular body.

4. Apparatus in accordance with claim 1 wherein said container further comprises a handle formed integrally with said body storage portion.

5. Apparatus in accordance with claim 4 wherein said body handle is at least partially defined by a recess within said body.

6. Apparatus in accordance with claim 1 wherein said control mechanism comprises an actuator extending outward from said dispensing portion third opening for selectively opening and closing said third opening.

7. Apparatus in accordance with claim 1 wherein said third opening couples said surface portion in flow communication with said dispensing portion.

8. Apparatus in accordance with claim 1 wherein said shaker cap comprises a lid hingedly coupled to said shaker cap to selectively control access to said at least one second opening.

9. Apparatus in accordance with claim 1 wherein a portion of said rotating member extends into said dispensing portion third opening.

10. A particulate dispenser comprising:
a hollow container comprising a body extending from a top end to a bottom end, said body comprising a storage portion and a dispensing portion in flow communication with said storage portion;
a shaker cap removably coupled to said container top end to selectively control access to a first opening defined in said top end, said cap comprising at least one second opening;
a third opening integrally formed within a side wall of said dispensing portion;
a control mechanism coupled in communication with said dispensing portion third opening for controlling particulate flow from said storage portion to said dispensing portion; and
a dispensing handle comprising a collapsible arm, said handle operable to selectively discharge particulate from said dispensing portion.

11. Apparatus in accordance with claim 10 further comprising a dispensing mechanism rotatably coupled within said container body, said handle selectively operable to control operation of said dispensing mechanism.

12. Apparatus in accordance with claim 10 wherein said shaker cap comprises a lid hingedly coupled to said shaker cap to selectively control access to said cap at least one opening.

13. Apparatus in accordance with claim 10 further comprising a handle formed integrally with said container.

14. Apparatus in accordance with claim 13 wherein said handle is at least partially defined by a recess formed within said container body.

15. A method for dispensing particulate from a container having a body extending from a top end to a bottom end, said method comprising:
inserting a particulate to be dispensed from the container into a storage portion of the container body through a first opening formed in the top end of the container;
coupling a lid to the container to facilitate preventing particulate from inadvertently exiting the container through the first opening; and
selectively dispensing particulate from the container through at least one of a second opening formed in the lid and a third opening formed in a dispensing portion of the container, wherein the dispensing portion of the container is positioned in flow communication with the storage portion of the container.

16. A method in accordance with claim 15 wherein selectively dispensing particulate from the container comprises:
at least partially inverting the container; and
discharging particulate matter from the container through a plurality of shaker openings formed in the lid.

17. A method in accordance with claim 15 wherein selectively dispensing particulate from the container comprises transferring particulate from the body storage portion through the third opening to the dispensing portion through a control mechanism that is selectively operable to control a flow of particulate.

18. A method in accordance with claim 17 wherein transferring particulate from the body storage portion to the dispensing portion further comprises rotating a handle to cause particulate to be broadcast discharged from the container.

19. A method in accordance with claim 15 wherein selectively dispensing particulate from the container comprises opening a valve that is coupled in flow communication with the body storage portion.

20. A method in accordance with claim 15 wherein selectively dispensing particulate from the container comprises rotating a rotating member positioned within the body dispensing portion.
